(19) United States
(12) Patent Application Publication
(10) Pub. No.: US 2008/0008300 A1
(43) Pub. Date: Jan. 10, 2008

(54) Method in a communication device for processing calls

(75) Inventors: Jeff Brandt, Cedar Park, TX (US); Philip Kortum, Houston, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/311,577

(22) Filed: Dec. 15, 2005

(51) Int. Cl. H04M 1/64

(52) U.S. Cl. 379/88.22

(57) ABSTRACT

A system and method are disclosed for processing calls in a communication device (102, 104). A system that incorporates teachings of the present disclosure may include, for example, a communication device having a controller (206) for managing operations of a transceiver (202) that exchanges messages with third party communication devices in a communication system, and a user interface (UI) (204) for exchanging messages with an end user of the communication device. The controller can be programmed to receive (310) an incoming call from a calling party by way of a third party communication device, notify (311) the end user of the incoming call, receive (314) a selection from the end user corresponding to one among a plurality of recorded messages, accept (318) the incoming call, and present (324) the selected recorded message to the calling party. Additional embodiments are disclosed.

### FIELD OF THE DISCLOSURE

The present disclosure relates generally to call processing techniques, and more specifically to a method in a communication device for processing calls.

### BACKGROUND

The advent of voicemail has provided a means for informing a calling party that the recipient of the call is unavailable. Often a targeted party does not answer an incoming call because s/he is busy with a task, or is in the midst of a presentation in which answering the call would interrupt others in the vicinity (e.g., a movie theater, or religious ceremony).

### BRIEF DESCRIPTION OF THE DRAWINGS

FIG. 1 depicts an exemplary embodiment of communication devices operating in a communication system;

FIG. 2 depicts an exemplary block diagram of the communication devices of the communication system;

FIG. 3 depicts an exemplary method operating in the communication devices; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method in a communication device for processing calls.

In a first embodiment of the present disclosure, a communication device has a controller for managing operations of a transceiver that exchanges messages with third party communication devices in a communication system, and a user interface (UI) for exchanging messages with an end user of the communication device. The controller is programmed to receive an incoming call from a calling party by way of a third party communication device, notify the end user of the incoming call, receive a selection from the end user corresponding to one among a plurality of recorded messages, accept the incoming call, and present the selected recorded message to the calling party.

In a second embodiment of the present disclosure, a computer-readable storage medium operates in a communication device. The storage medium has computer instructions for receiving an incoming call from a calling party by way of a third party communication device, notifying an end user of the incoming call, receiving a recorded message from the end user, accepting the incoming call, and presenting the recorded message to the calling party.

In a third embodiment of the present disclosure, method operates in a communication device. The method includes the steps of recording greetings for processing incoming calls, receiving an incoming call from a calling party by way of a third party communication device, notifying an end user of the incoming call, receiving a selected greeting from the end user, accepting the incoming call, presenting the selected greeting to the calling party, and processing the accepted call according to call processing instructions associated with the selected greeting.

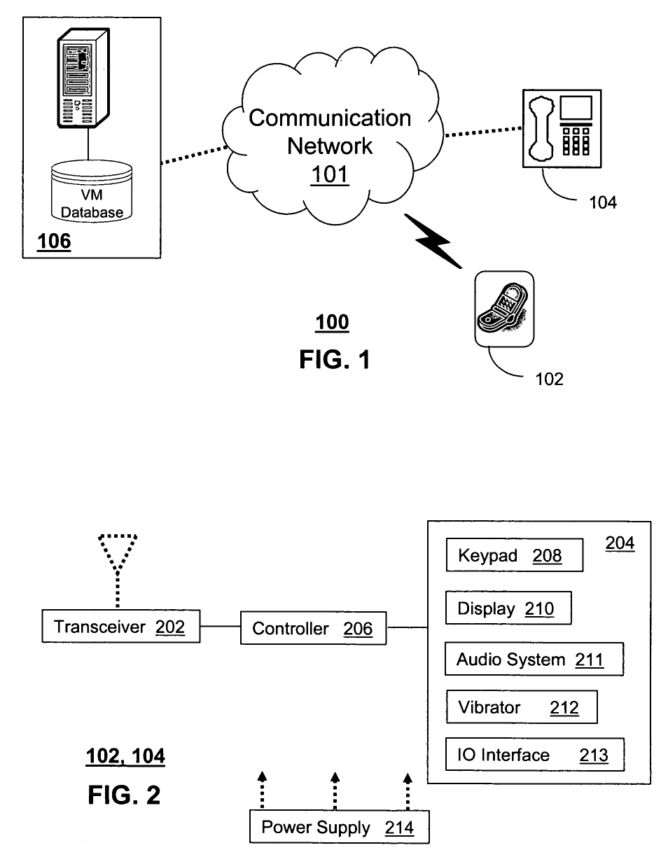

FIG. 1 depicts an exemplary embodiment of communication devices 102, 104 operating in a communication system 100. Communication device 102 represents a wireless communications device capable of exchanging wireless messages with the communication network 101. The wireless messages can comply with any number of wireless access technologies such as, for example, cellular, software defined radio (SDR), WiMAX, WiFi, or Bluetooth™ technologies, just to mention a few. Cellular technologies can include, for example, CDMA-1X, UMTS/HSDPA, GSM/GPRS, TDMA/EDGE, EV/DO, and next generation technologies as they arise. The communication device can be a single mode or multimode communication device supporting circuit-switched and/or packet-switched communications (e.g., Voice over IP or VoIP).

In an alternative embodiment, the communication device 104 can be represented by a wireline communications device supporting wireline communications with a PSTN (Public Switched Telephone Network). In this embodiment, the communication device 104 can similarly support circuit-switched or packet-switched communications over DSL or cable interfaces (e.g., VoIP). Moreover, the communication device 104 can be embodied in a cordless communication device that communicates wirelessly within a given range with a base unit wired to a PSTN interface.

The communication network 101 can represent a hybrid communications network supporting the aforementioned wireless and wireline communication techniques. The communication network 101 can also be coupled to a conventional voicemail (VM) system 106 that stores voicemail messages from calling parties who fail to reach end user's of the communication devices 102, 104.

FIG. 2 depicts an exemplary embodiment of the communication devices 102, 104 of the communication system 100. The communication devices 102, 104 can comprise a transceiver 202, a user interface (UI) 204, a power supply 214, and a controller 206 for managing operations thereof. In the case of communication device 102, the transceiver 202 utilizes common wireless communication technology that supports the aforementioned access technologies (i.e., cellular, SDR, WiMAX, WiFi, Bluetooth™). For communication device 104, the transceiver 202 can represent in part a wireline transceiver supporting PSTN communications, and wireless communications for a cordless handset. The UI 204 can include a depressible keypad 208 for manipulating operations of the communication device 102, a display 210 such as monochrome or color LCD (Liquid Crystal Display) for conveying images to the end user of the communication device 102, an audio system 211 utilizing common audio technology for conveying and intercepting audible signals of the end user, a vibrator 212 to notify the end user of an event, an 10 (Input/Output) interface 213 for exchanging data (such as provisioning information) with an external source by wired or wireless means.

For communication device 102, the power supply 214 can utilize common power management technologies such as replaceable batteries, supply regulation technologies, and charging system technologies for supplying energy to the components of the communication device 102 to facilitate portable applications. For communication device 104, the power supply 214 can utilize common transformer technology for supplying DC power to the base unit and the cordless handset. Alternatively, the communication device 104 can derive power from the PSTN line itself. The controller 206 can utilize computing technologies such as a microprocessor and/or digital signal processor (DSP) with associated storage memory such a Flash, ROM, RAM, SRAM, DRAM or other like technologies.

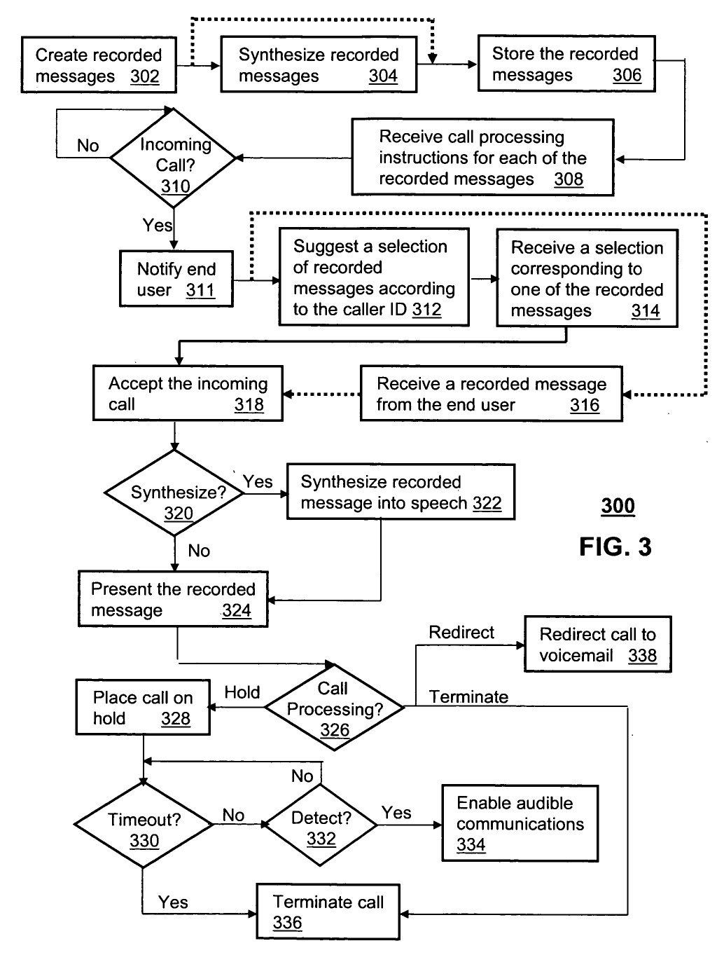

FIG. 3 depicts an exemplary method 300 operating in either of the communication devices 102, 104. Method 300 begins with step 302 where the controller 206 can be programmed to create user selectable recorded messages supplied by the end user of the communication device. The recorded messages can be created from the end user's voice as customized message greetings. A number of greetings can be created by the end user. Some of these greetings can be generic and therefore applicable to any caller, while other greetings can be tailored for specific callers. For example, the following recorded messages of the end user's voice can be used as a set of generic greetings, “Hello, please hold a moment while I move to a location where we can speak privately”, “Hello, I need to step outside so we can talk. I'll be with you in a moment. Don't hang up.”, “Hello, I'm really busy right now, so I'm going to direct you to my voicemail system”, or “Hello, I'm on the other line. I'll call you later.”

Alternatively, the end user can select from greetings tailored to calling parties identified by way of a caller ID. The following represent examples of tailored greetings, “Hi Mom, I'm on the other line, I'll call you later.”, “Hi Johnny, I need to step outside so we can talk. I'll be with you in a moment. Don't hang up.”, or “Hi Sam, I'm on the other line. Please leave me a voicemail”. For efficient use of the greetings and to conserve memory, the end user can provide a recorded portion of the above tailored messages such as, for example, “Mom”, or “Johnny”. The controller 206 can combine or insert these portions into the generic greetings to complete the tailored greetings above (e.g., “Hi <Mom>, I'm on the other line, I'll call you later.”).

Alternatively, the audible signals of the end user can be synthesized into text by a common voice-to-text synthesizer operating in the controller 206 in step 304. In yet another embodiment, the end user can supply text messages by way of the UI 204 (e.g., using the keypad 208 or IO interface 213 coupled to a computer that supplies the recorded messages). In either embodiment, the recorded messages are represented by text messages instead of the end user's voice. Recorded messages in text provide an efficient means for storage in communication devices with limited storage capacity.

Once the recorded messages have been processed, the controller 206 proceeds to step 306 where it stores the messages in its local memory. In step 308, the controller 206 can be programmed to receive from the end user by way of the UI 204 call processing instructions for each of the recorded messages. The call processing instructions instruct the controller 206 how to go about processing an incoming call. These instructions will be described shortly.

If an incoming call is detected in step 310, the controller 206 proceeds to step 311 where it notifies the end user by way of the UI 204. The notification can be audible, tactile (e.g., vibration), and/or visual. In step 312, the controller 206 can be programmed to suggest a selection of recorded messages according to a caller ID supplied by the communication network 101. The controller 206 can, for example, have a phonebook stored in its memory banks which the end user can associate with a number of the recorded messages created in steps 302-306. Thus, the end user can select tailored recorded messages for calls received from family, friends, and business colleagues.

Accordingly in step 312, the controller 206 can be programmed to present greeting options to the end user by way of the display 210. The controller 206 receives from the end user in step 314 a selection of a recorded message from an entry in the UI 204 (e.g., the keypad 208). Alternatively, the controller 206 can proceed to step 316 where it receives a recorded message from the end user. The recorded message can be selected from the generic list mentioned above, or can be a recorded message which the end user creates in real-time by way of the UI 204. In the latter case, the end user can, for example, state or input in text a recorded message with call processing instructions. If the end user knows the caller by way of the caller ID, the message created in real-time can be tailored to the caller. Otherwise, the end user can input a generic statement.

Once the recorded message has been supplied by the end user, the controller 206 proceeds to step 318 where it accepts the incoming call. If the controller 206 detects in step 320 that the recorded message is in text, it proceeds to step 322 where it synthesizes the message into speech. If the recorded message is already in speech, or has been synthesized to speech in step 322, the controller 206 proceeds to step 324 where it presents the recorded message to the calling party by way of a circuit-switched or packet-switched voice channel depending on the type of call transaction. The controller 206 in step 326 then determines how to process the call by way of the call processing instructions provided by the end user in step 308 for the selected recorded message.

If the call processing instructions call for placing the calling party on hold, the controller 206 proceeds to step 328. Subsequent to this step controller 206 checks in step 330 whether the hold time exceeds a predetermined period (e.g., 30 seconds). The predetermined period can be a default setting or a programmable setting entered by the end user by way of the UI 204. If the hold time has not timed out, the controller 206 proceeds to step 332 where it awaits a detectable action by the end user to enable the audio system 211 (i.e., microphone and speaker portions). The detectable action can be any number of things such as, for example, opening a flip assembly of the communication device 102, or lifting the handset of the communication device 104 from the base unit. If such action is detected, the controller 206 proceeds to step 334 where it enables audible communications between the calling party and the end user. Otherwise, the controller 206 checks again whether the timeout period has expired in step 330. If time has expired, the controller 206 proceeds to step 336 where it terminates the call. The foregoing call processing instruction would be applicable for a greeting message such as, “Hi Johnny, I need to step outside so we can talk. I'll be with you in a moment. Don't hang up.”

Alternatively, the end user could have specified in the recorded message call processing instructions in which the controller 206 proceeds from step 326 to step 338 for redirecting the call to voicemail system 106. The recorded message for this use case might say, “Hello Sam, I'm really busy right now, so I'm going to direct you to my voicemail system. Please make sure to leave a message. Thanks.” Alternatively, the end user could have specified call processing instructions to terminate the call after the greeting message in which case the controller 206 would proceed to step 336. A greeting message in this instance might say, “Hi Mom, I'm really busy right now. I'll call you later.”

Method 300 illustrates several embodiments that provide the end user a means to selectively process calls with any number of generic or tailored recorded greeting messages. There are many other embodiments that can be applied to the present disclosure for processing calls that are not disclosed. For these embodiments, the reader's attention is directed to the claims described below.

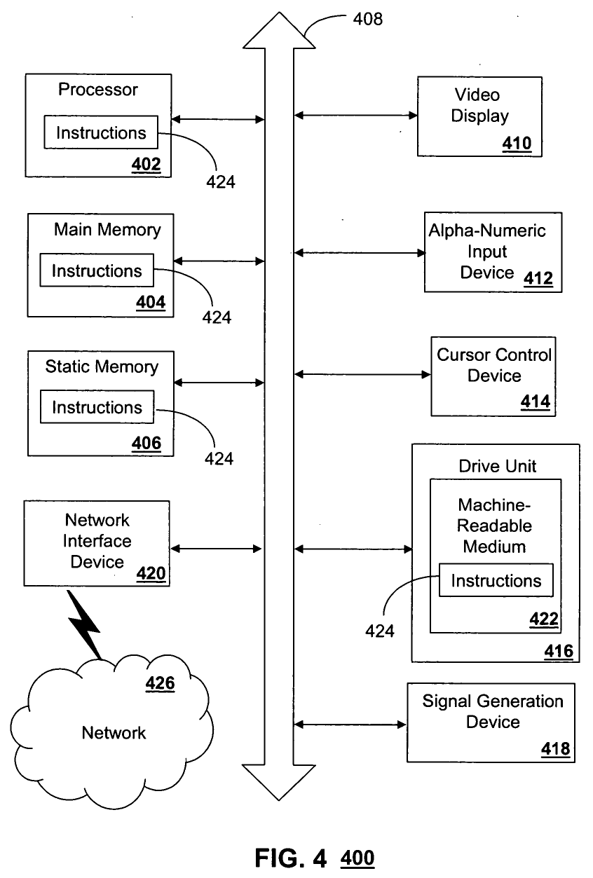

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communication device, comprising:
a controller that manages operations of a transceiver for exchanging messages with third party communication devices in a communication system, and to manage a user interface (UI) for exchanging messages with an end user of the communication device, wherein the controller is programmed to:
receive an incoming call from a calling party by way of a third party communication device;
notify the end user of the incoming call;
receive a selection from the end user corresponding to one among a plurality of recorded messages;
accept the incoming call; and
present the selected recorded message to the calling party.

2. The communication device of claim 1, wherein the controller is programmed to:
create the plurality of recorded messages from audible signals of the end user; and
store the plurality of recorded messages.

3. The communication device of claim 1, wherein the controller is programmed to place the accepted call on hold.

4. The communication device of claim 1, wherein the controller is programmed to terminate the accepted call after presenting the selected recorded message.

5. The communication device of claim 1, wherein the controller is programmed to redirect the accepted call to voicemail after presenting the selected recorded message.

6. The communication device of claim 1, wherein the controller is programmed to:
create the plurality of recorded messages from text supplied by the end user;
store the plurality of recorded messages;
generate a synthesized speech message from the selected recorded message; and
present the synthesized speech message to the calling party.

7. The communication device of claim 1, wherein the controller is programmed to:
synthesize audible signals of the end user into a plurality of text messages, each of the text messages corresponding to a select one of the plurality of recorded messages;
store the plurality of recorded messages;
generate a synthesized speech message from the selected recorded message; and
present the synthesized speech message to the calling party.

8. The communication device of claim 1, wherein the controller is programmed to receive call processing instructions from the end user for each of the recorded messages.

9. The communication device of claim 2, wherein the controller is programmed to selectively place the accepted call on hold, terminate the accepted call, or redirect the accepted call to voicemail according to the call processing instructions associated with the selected recorded message.

10. The communication device of claim 8, wherein the controller is programmed to suggest a selection of one or more recorded messages to the end user according to call processing instructions associated with the caller ID.

11. The communication device of claim 1, wherein the transceiver comprises at least one among a wireless transceiver and a wireline transceiver.

12. A computer-readable storage medium in a communication device, comprising computer instructions for:
receiving an incoming call from a calling party by way of a third party communication device;
receiving a recorded message from the end user in response to the incoming call;
accepting the incoming call; and
presenting the recorded message to the calling party.

13. The storage medium of claim 12, comprising computer instructions for:
receiving a text message from the end user by way of a user interface (UI), wherein the text message corresponds to the recorded message;
synthesizing the text message into a speech message; and
presenting the speech message to the calling party.

14. The storage medium of claim 12, comprising computer instructions for:
receiving a speech message from the end user by way of UI, wherein the speech message corresponds to the recorded message;
presenting the speech message to the calling party.

15. The storage medium of claim 12, comprising computer instructions for:
receiving a plurality of messages from the end user by way of a UI;
storing the plurality of messages as recorded messages; and
receiving a selection from the end user corresponding to one among the plurality of recorded messages, wherein the selected recorded message corresponds to the recorded message.

16. The storage medium of claim 12, comprising computer instructions for placing the accepted call on hold.

17. The storage medium of claim 16, comprising computer instructions for enabling audible communications between the calling party and the end user in response to a detectable action of the end user.

18. The storage medium of claim 16, comprising computer instructions for terminating the accepted call after expiration of a predetermined period in which no action is detected from the end user.

19. The storage medium of claim 12, comprising computer instructions for:
receiving call processing instructions from the end user for the recorded message; and
selectively placing the accepted call on hold, terminating the accepted call, or redirecting the accepted call to voicemail according to the call processing instructions associated with the recorded message.

20. A method in a communication device, comprising:
recording greetings for processing incoming calls;
receiving an incoming call from a calling party by way of a third party communication device;
notifying an end user of the incoming call;
receiving a selected greeting from the end user;
accepting the incoming call;
presenting the selected greeting to the calling party; and
processing the accepted call according to call processing instructions associated with the selected greeting.
